(19) United States
(12) Patent Application Publication
(10) Pub. No.: US 2007/0283034 A1
(43) Pub. Date: Dec. 6, 2007

(54) METHOD TO SUPPORT DATA STREAMING IN SERVICE DATA OBJECTS GRAPHS

(76) Inventors: Adam R. Clarke, Raleigh, NC (US); Matthew J. Hicks, Morrisvile, NC (US); Joseph J. Kubik, Cary, NC (US)

Correspondence Address: HOFFMAN WARNICK & DALESSANDRO LLC, 75 STATE ST, 14TH FLOOR, ALBANY, NY, 12207, US

(21) Appl. No.: 11/421,250

(22) Filed: May 31, 2006

(51) Int. Cl. G06F 15/16

(52) U.S. Cl. 709/231; 709/203

(57) ABSTRACT

The present invention provides a method, system, and program product to support data streaming in service data object (SDO) graphs. Specifically, under the present invention, the method includes attaching a binary object stream to a SDO graph; streaming the binary object to a repository; and also streaming the SDO graph to the repository. A system, program product stored on a computer readable medium, and method for deploying an application for providing data streaming in SDO graphs is also disclosed.

### CROSS-REFERENCE TO RELATED APPLICATIONS

This application is related in some aspects to the commonly assigned and co-pending application identified by attorney docket number RSW920050205US1, assigned United States application serial number (to be provided), entitled “Method, System, and Program Product for Providing Proxies for Data Objects”, and filed on May 31, 2006, the entire contents of which are herein incorporated by reference. This application is also related in some aspects to the commonly assigned and co-pending application identified by attorney docket number RSW920050217US1, assigned U.S. application Ser. No. 11/395,673, entitled “Method, System, and Program Product for Managing Adapter Association for a Data Graph of Data Objects”, and filed on Apr. 3, 2006, the entire contents of which are herein incorporated by reference.

### BACKGROUND OF THE INVENTION

1. Field of the Invention

The present invention generally relates to the efficient transfer of large amounts of data using a service data object (SDO). Specifically, the present invention provides a method, system, and program product to support data streaming in SDO graphs.

2. Related Art

The service data object (SDO) specification is gaining wide-spread adoption in service-oriented architectures. Within the SDO specification, a SDO graph may be provided. A SDO graph is generally a graph of related objects.

Service Data Objects (SDOs) are an abstract way to view data from heterogeneous sources. Layer code, called a mediator, creates data graphs and updates the “back end” (i.e., content repository).

The SDO architecture and its storage of documents and data is, in essence, an “in memory” model. Typically, SDO's are very large (e.g., gigabytes) and when one goes to retrieve a SDO graph, the data and documents that are being retrieved are, thusly, read into memory. Therefore, this can be slow and problematic for the system attempting to send and/or retrieve SDO graphs.

Documents include metadata (e.g., author, owner, attributes, characteristics, etc.) and the body (i.e., actual data or text of the documents). The problem is exacerbated because the body may be exceedingly large as compared to metadata.

In view of the foregoing, there exists a need for a solution that addresses one or more of the deficiencies in the related art.

### SUMMARY OF THE INVENTION

In general, the present invention provides a method, system, and program product to support data streaming in service data object (SDO) graphs. Specifically, under the present invention, the method includes attaching a binary object stream to a SDO graph; streaming the binary object to a repository; and also streaming the SDO graph to the repository. A system, program product stored on a computer readable medium, and method for deploying an application for providing data streaming in SDO graphs are also disclosed.

A first aspect of the present invention provides a method for data streaming in service data object (SDO) graphs, comprising: attaching a binary object stream to a SDO graph; streaming the binary object to a repository; and streaming the SDO graph to the repository.

A second aspect of the present invention provides a system for data streaming in service data object (SDO) graphs, comprising: a system for attaching a binary object stream to a SDO graph; a system for streaming the binary object to a repository; and a system for streaming the SDO graph to the repository.

A third aspect of the present invention provides a program product stored on a computer readable medium for providing data streaming in service data object (SDO) graphs, the computer readable medium comprising program code for causing a computer system to perform the following: attaching a binary object stream to a SDO graph; streaming the binary object to a repository; and streaming the SDO graph to the repository.

A fourth aspect of the present invention provides a method for deploying an application to support data streaming in service data object (SDO) graphs, comprising: providing a computer infrastructure being operable to: attach a binary object stream to a SDO graph; stream the binary object to a repository; and stream the SDO graph to the repository.

Therefore, the present invention provides a method, system, and program product to support data streaming in service data object (SDO) graphs.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts the interaction and flow of Java Classes and Java Interfaces in accordance with an embodiment of the present invention.

FIG. 2 depicts an attachment of a binary object to a service data object (SDO) graph in accordance with an embodiment of the present invention.

FIG. 3 depicts a local example of data streaming of SDOs graphs in accordance with an embodiment of the present invention.

FIG. 4A depicts a remote example of staging of a binary object and replacement with a staging uniform resource identifier (URI) in accordance with an embodiment of the present invention.

FIG. 4B depicts a remote example of data streaming of SDO graphs in accordance with an embodiment of the present invention.

FIG. 5 depicts an environment for data streaming a SDO graph from a first system to a repository in a second system in accordance with an embodiment of the present invention.

FIG. 6 depicts a more specific computerized implementation in accordance with an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The present invention provides a method, system, and program product for providing data streaming in service data object (SDO) graphs. Specifically, under the present invention, the method includes attaching a binary object stream to a SDO graph; streaming the binary object to a repository; and also streaming the SDO graph to the repository. A system, program product stored on a computer readable medium, and method for deploying an application for providing data streaming in SDO graphs is also disclosed.

Under the present invention, a body of the data can be retrieved directly from a “back end” storage repository (e.g., database), rather than being brought into memory. In so doing, a “pointer”, or identifier, is brought into memory rather than including the body of data with the other metadata. This allows for the efficient data streaming of large blocks of data included in SDO graphs.

An embodiment of the invention includes creating a new data type (e.g., DataStream) that seamlessly handles the transfer of data streams from a repository. The new data type, combined with a mediator processing logic allows for standard SDO graphs to incorporate this new functionality and still be able to be serialized and remoted.

Embodiments of the present invention may be implemented using an object-oriented language, such as Java. Discussed herein using Java as an example, take an application that wants to model and interact with a Document object that has a ‘name’ property and a ‘content’ property. The ‘name’ property is of type String and the ‘content’ property is of the new type, DataStream. To create a document, the user may create a new document and set the name, using the setName(String) method. Next, the user would create a FileInputStream, given a file on a filesystem, and create a DataStream using a DataStreamFactory's createDataStream(InputStream) method. Lastly, the user may set the DataStream on the document using setContent(DataStream). The SDO graph may be sent to the mediator and the filesystem file would be streamed directly into the repository and never read into memory.

In an embodiment for retrieving a SDO graph, the user may be given a document by the mediator, and retrieve the name by calling getName( ). Next, the user may retrieve the content by calling getContent( ), which returns a DataStream and then the DataStream's getInputStream( ) method which returns a stream to the repository data. In both cases, large amounts of data (e.g., SDO graphs) are never read into memory, they are always streamed.

Amongst other advantages, the present invention offers a solution that provides a programming methodology that is very clear to the user and strongly typed. The user does not have to address properties that may or may not be null and does not need to retrieve data from separate systems that support streaming the data. Further, in applications that define objects containing heterogeneous properties that are tightly coupled, this solution allows them to model and interact with all of the properties in a way that still prescribes to the SDO methodology, but is extremely efficient when dealing with properties containing large amounts of data (e.g., SDO graphs).

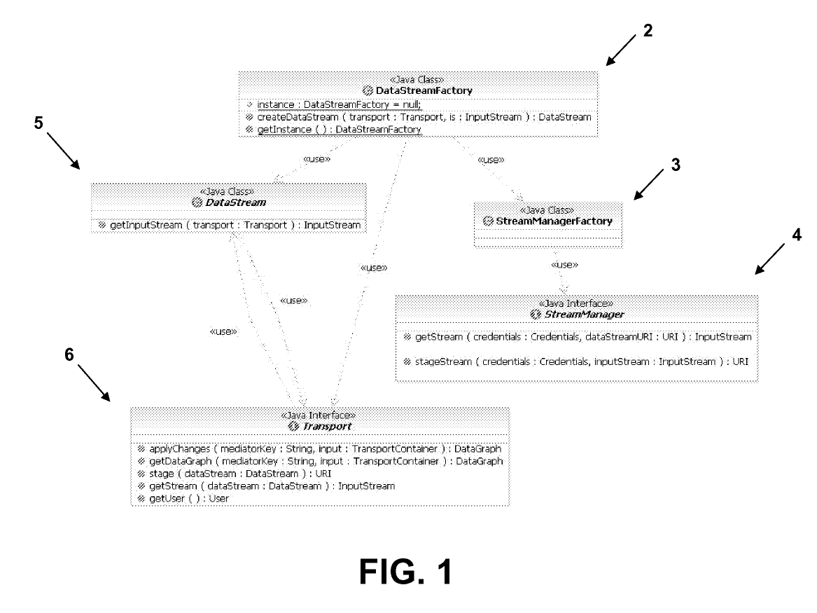

FIG. 1 shows an environment employing Java for providing a method to support data streaming in SDO graphs in accordance with an embodiment of the present invention. Employed are Java Classes such as a DataStreamFactory 2, a StreamManagerFactory 3, and a DataStream 5. Further, Java Interfaces may include a StreamManager 4, and a Transport 6. Thus, as FIG. 1 shows, the present invention can be realized using Java classes.

As shown, the DataStreamFactory 2 allows a user (not shown) to create a DataStream 5 type if given, for example, an InputStream and a LoginContext. The LoginContext encapsulates credentials required to make a remote call to stream or retrieve the data, if necessary.

The StreamManagerFactory 3 provides for the management of access to StreamManager 4 instances. This allows the StreamManager 4 objects to be managed efficiently by either pooling StreamManager objects to client applications or by implementing the “Singleton” design pattern. Additionally, the StreamManagerFactory 3 may allow multiple different implementations of StreamManager 4 in order to allow for plugging in new implementations to support additional repository implementations.

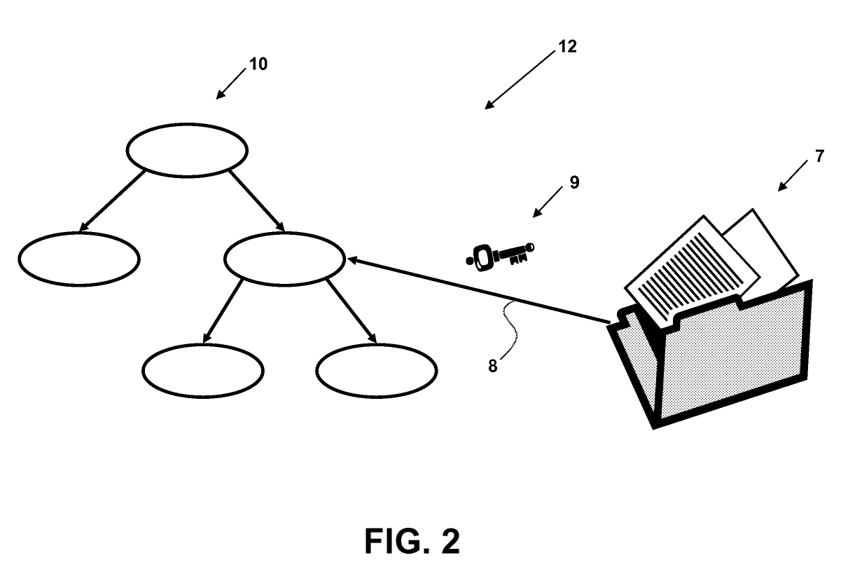

DataStream 5 allows the user to attach an InputStream to SDO graph 10 (See e.g., FIG. 2) and thereby stream contents of SDO graph 10 without storing SDO graph 10 in memory. When the DataStream 5 is serialized, the InputStream is staged to a temporary location until applyChanges (see in Transport 6) is called and the DataStream 5 is accessed again.

The StreamManager 4 is responsible for managing the streaming of objects. The StreamManager 4 handles the staging of streams to a server on persist operations and the retrieval of streams on read operations. StreamManager 4 may be used to manage the staging and retrieval of the DataStream 5.

The Transport 6 abstracts out the underlying mechanism for communicating with the data repository. The transport 6 may use a pluggable StreamManager 4 which is uniform resource identifier (URI) based.

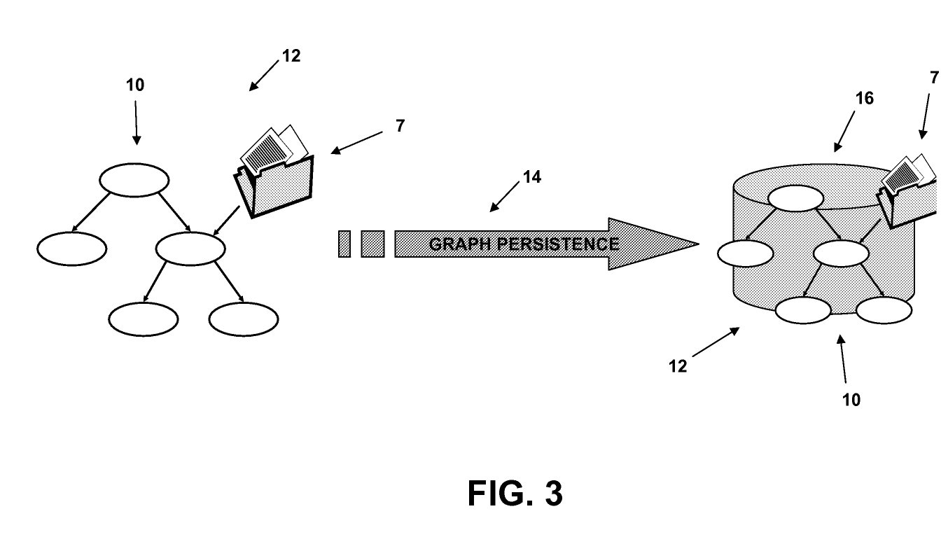

Referring to FIGS. 2 and 3, a graphical representation of data streaming of a SDO graph 10, in a local environment is shown. The use of the term “local” herein includes, but is not limited to, a scenario where both the repository and client application reside at the same physical location; in the same machine; the repository and client application are communicating using a one-to-one communication; and/or the like. A user (not shown) attaches a binary object 7 to a SDO graph 10. The attachment 8 may be done using a DataStream object. The attachment 8 may include using a security detection element 9, wherein the user must supply, for example, credentials in order to complete the attachment 8 of the binary object 7 to the SDO graph 10. Upon the attachment 8, a datagraph 12 results. In the local environment embodiment, the DataStream 5 (FIG. 1) stores the InputStream throughout the entire data streaming process.

Turning to FIG. 3, the datagraph 12 is streamed (e.g., persisted) 14 directly into a repository 16. The repository 16 may be, for example, a database, a storage device, or any suitable repository. On occasion, the term “back end storage” may be used for the repository 16. The right portion of FIG. 3 shows the state, or condition, of the repository 16 after a mediator has persisted 14 the datagraph 12. In this manner, the attached binary object 7 is persisted to the repository 16 without requiring reading the entire contents (e.g., SDO graph 10) into memory.

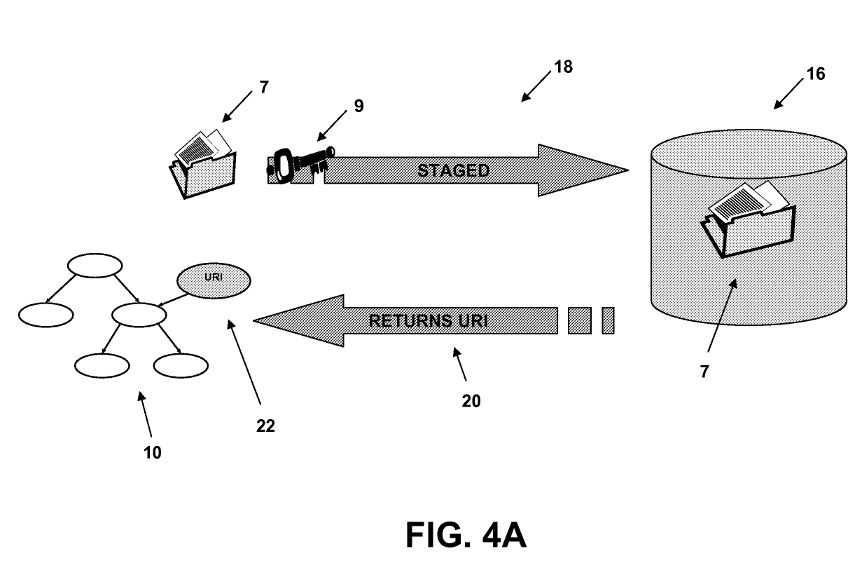

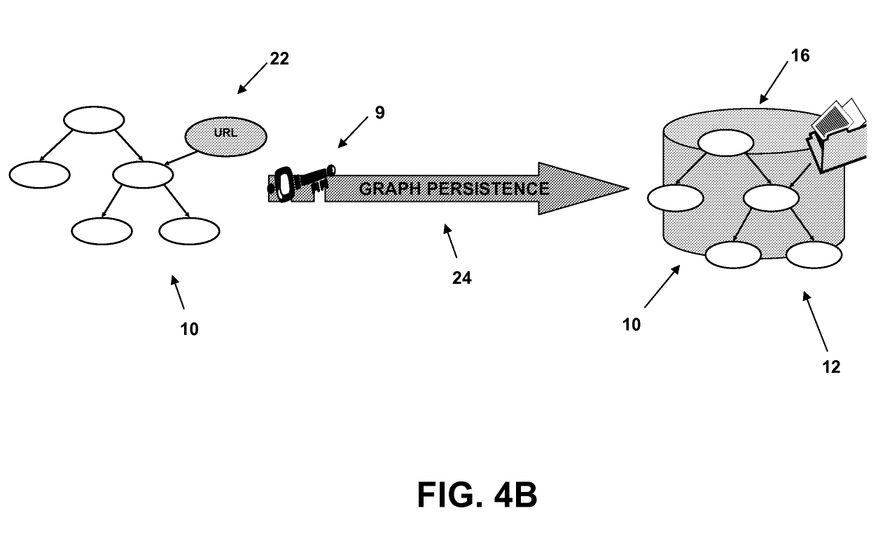

An example of data streaming a SDO graph 10 in a remote and/or clustered environment, is shown in FIG. 2 and FIGS. 4A and 4B. The use of the term “remote” herein includes, but is not limited to, scenarios wherein the physical location of the repository 16 and client application(s) are on different machines and/or systems; the repository 16 and client application(s) communicate over a multi-user network(s); and/or the like. As a result, there will typically be a network connection between the two machines/systems in the remote scenario. In this embodiment, the datagraphs 12 are serialized without the binary object 7 (FIG. 4A). Data streaming in the remote environment starts with the same steps, discussed herein, as shown in FIG. 2. A user (not shown) attaches a binary object 7 to a SDO graph 10, typically using a DataStream object. The attachment 8 may include using a security detection element 9, wherein the user must supply, for example, credentials in order to complete the attachment 8 of the binary object 7 to the SDO graph 10. Upon the attachment 8, a datagraph 12 results (FIG. 2).

FIG. 4A depicts the next steps of streaming of SDO graph 10 in a remote environment. The binary object 7 is staged 18 in the repository 16 and the DataStream object is updated with a uniform resource identifier (URI) 22. As shown, the repository 16 returns 20 the URI 22 for attachment to the SDO graph 10.

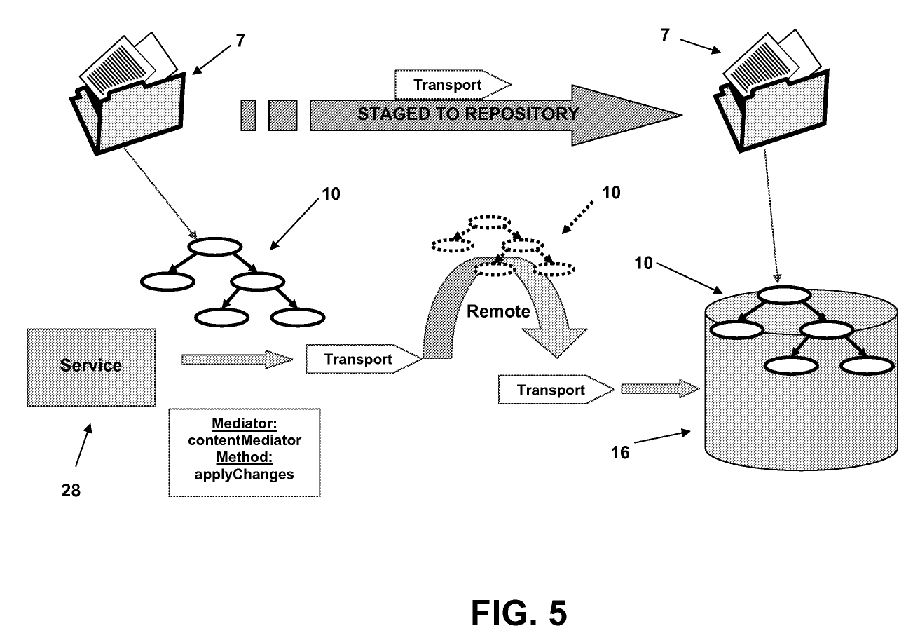

The completion of data streaming of SDO graph 10 in a remote environment is shown in FIG. 4B. The SDO graph 10 with URI 22 is persisted 24 to the repository 16. At the repository 16, when the mediator (see e.g., FIG. 5) encounters the URI 22 in place of the input streams, it will stream the binary object 7 from a staging location to a final location in the repository 16. Alternatively, the repository 16 may optimize this step by only pointing to the location of the binary object 7 in the repository 16. That is, in this alternative embodiment, it is not necessary for the repository 16 to copy the body of binary object 7. The staging location may end up being the final location. In either event, the SDO graph 10 ultimately persists with the binary object 7 to the repository 16. In either method (e.g., local or remote), an SDO graph 10 is successfully streamed.

As FIG. 5 depicts, streaming a SDO graph 10 from a first system (e.g., “Service”) 28 to a second system (e.g., repository) 16 is shown. The SDO graph 10 is in the Service 28 and requires transporting to the repository 16. A binary object 7 is attached to the SDO graph 10 with a data stream. The binary object 7 is staged (via streaming) to the repository 16. The SDO graph 10 is serialized for the remote call. After serialization, the repository 16 then processes the SDO graph 10 and re-associates the SDO graph 10 with the binary object 7.

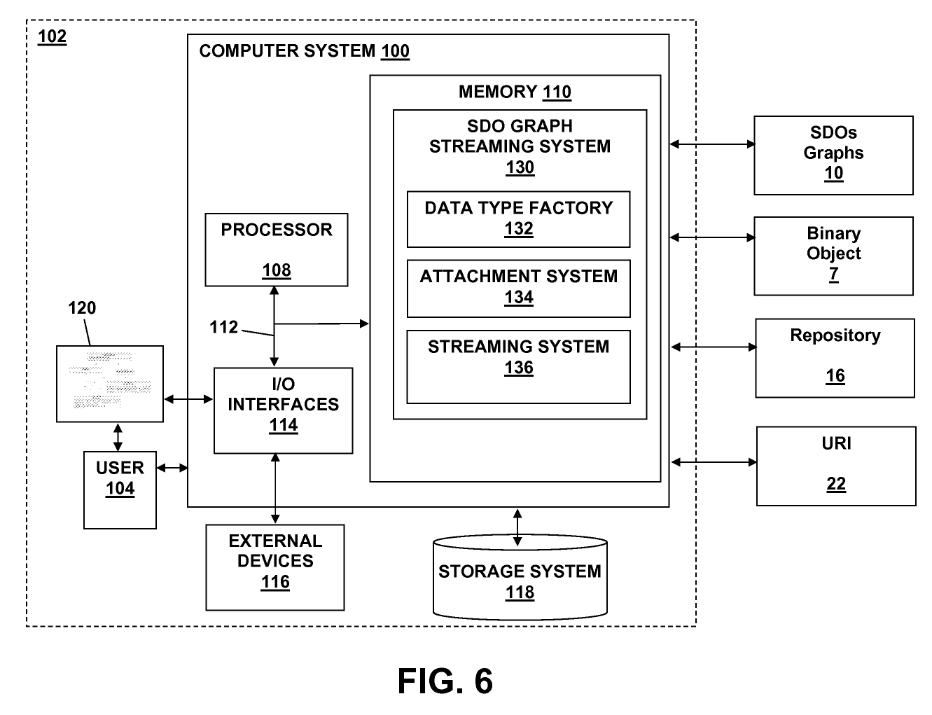

Referring now to FIG. 6, a more detailed diagram of a computerized implementation of the present invention is shown. As depicted, implementation includes a computer system 100 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation could be deployed, managed, serviced, etc. by a service provider who offers to provide data streaming in SDOs graphs.

As shown, computer system 100 includes a processor 108, a memory 110, a bus 112, and input/output (I/O) interfaces 114. Further, computer system 100 is shown in communication with external I/O devices/resources 116 and storage system 118. In general, processor 108 executes computer program code, such as SDO graph streaming system 130, which is stored in memory 110 and/or storage system 118. While executing computer program code, processor 108 can read and/or write data to/from memory 110, storage system 118, and/or I/O interfaces 114. Bus 112 provides a communication link between each of the components in computer system 100. External devices 116 can comprise any devices (e.g., keyboard, pointing device, display, etc.) that enable a user to interact with computer system 100 and/or any devices (e.g., network card, modem, etc.) that enable computer system 100 to communicate with one or more other computing devices such as a server.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process steps of the invention. Moreover, computer system 100 is only representative of various possible computer systems that can include numerous combinations of hardware. To this extent, in other embodiments, computer system 100 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processor 108 may comprise a single processing unit, or be distributed across one or more processing units in one or more locations, e.g., on a client and server. Similarly, memory 110 and/or storage system 118 can comprise any combination of various types of data storage and/or transmission media that reside at one or more physical locations. Further, I/O interfaces 114 can comprise any system for exchanging information with one or more external devices 116. Still further, it is understood that one or more additional components (e.g., system software, math co-processing unit, etc.) not shown in FIG. 6 can be included in computer system 100. However, if computer system 100 comprises a handheld device or the like, it is understood that one or more external devices 116 (e.g., a display) and/or storage system(s) 118 could be contained within computer system 100, not externally as shown.

Storage system 118 can be any type of system (e.g., a database) capable of providing storage for information under the present invention such as SDOs, SDO graphs, data graphs, binary objects, data objects, reference objects, adapter data, etc. To this extent, storage system 118 could include one or more storage devices, such as a magnetic disk drive or an optical disk drive. In another embodiment, storage system 118 includes data distributed across, for example, a local area network (LAN), wide area network (WAN) or a storage area network (SAN) (not shown). Although not shown, additional components, such as cache memory, communication systems, system software, etc., may be incorporated into computer system 100.

Shown in memory 110 of computer system 100 is SDO graph streaming system 130, which includes data type factory 132, attachment system 134, and streaming system 136. These systems provide the functionality of the present invention discussed herein. It should be understood that although not shown, other programs such as components of a distributed application may be loaded on computer system 100.

In any event, SDO graph streaming system 130 ultimately supports data streaming in SDO graphs 10 in accordance with the present invention.

It should be understood that although FIG. 6 depicts a single SDO graph streaming system 130, this need not be the case. That is, SDO graph streaming system 130 could actually represent multiple SDO graph streaming systems 130. It should also be understood that the teachings of the present invention could be implemented on a stand-alone computer system 104 as shown, or in a distributed environment.

While shown and described herein as a method and system for providing data streaming in SDO graphs, it is understood that the invention further provides various alternative embodiments. For example, in one embodiment, the invention provides a computer-readable/useable medium that includes computer program code to enable a computer infrastructure to provide data streaming in SDO graphs. To this extent, the computer-readable/useable medium includes program code that implements each of the various process steps of the invention. It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 110 (FIG. 6) and/or storage system 118 (FIG. 6) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to provide data streaming in SDO graphs. In this case, the service provider can create, maintain, support, etc., a computer infrastructure, such as computer infrastructure 102 (FIG. 6) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing data streaming in SDO graphs. In this case, a computer infrastructure, such as computer infrastructure 102 (FIG. 6), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 100 (FIG. 6), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for data streaming in service data object (SDO) graphs, comprising:
attaching a binary object stream to a SDO graph;
streaming the binary object to a repository; and
streaming the SDO graph to the repository.

2. The method of claim 1, wherein the attaching further includes creating a data type.

3. The method of claim 2, wherein the data type is a data stream.

4. The method of claim 3, further comprising creating the data stream using an input stream and credentials.

5. The method of claim 4, further comprising configuring the data stream to wrap the input stream for delivery to a mediator.

6. The method of claim 1, wherein the streaming the binary object further includes:
staging the binary object in a staging location of the repository.

7. The method of claim 6, wherein the staging further includes:
streaming the binary object from the staging location to a final location of the repository.

8. The method of claim 1, wherein the repository is one selected from a group consisting of a database, a storage device, and a back end storage.

9. The method of claim 1, wherein Java classes implement at least one of the attaching, streaming the binary object, and streaming the SDO graph.

10. A system for data streaming in service data object (SDO) graphs, comprising:
a system for attaching a binary object stream to a SDO graph;
a system for streaming the binary object to a repository; and
a system for streaming the SDO graph to the repository.

11. The system of claim 10, wherein the system for attaching further includes a system for creating a data type.

12. The system of claim 11, wherein the data type is a data stream.

13. The system of claim 12, further comprising a system for creating the data stream wherein the system uses an input stream and credentials.

14. The system of claim 13, further comprising a system for configuring the data stream to wrap the input stream for delivery to a mediator.

15. The system of claim 10, wherein the system for streaming the binary object further includes:
a system for staging the binary object in a staging location of the repository.

16. The system of claim 15, wherein the system for staging further includes:
a system for streaming the binary object from the staging location to a final location of the repository.

17. The system of claim 10, wherein the repository is one selected from a group consisting of a database, a storage device, and a back end storage.

18. The system of claim 10, wherein Java classes implement at least one of the system for attaching, the system for streaming the binary object, and the system for streaming the SDO graph is done by Java classes.

19. A program product stored on a computer readable medium for providing data streaming in service data object (SDO) graphs, the computer readable medium comprising program code for causing a computer system to perform the following:
attaching a binary object stream to a SDO graph;
streaming the binary object to a repository; and
streaming the SDO graph to the repository.

20. A method for deploying an application for providing data streaming for service data object (SDO) graphs, comprising:
providing a computer infrastructure being operable to:
attach a binary object stream to a SDO graph;
stream the binary object to a repository; and
stream the SDO graph to the repository.
